(19) United States
(12) Patent Application Publication
(10) Pub. No.: US 2002/0050497 A1
(43) Pub. Date: May 2, 2002

(54) Shutoff device

(76) Inventor: Dieter Zosel, Dueren (DE)

Correspondence Address: CROWELL & MORING LLP, INTELLECTUAL PROPERTY GROUP, P.O. BOX 14300, WASHINGTON, DC, 20044-4300, US

(21) Appl. No.: 09/976,453

(22) Filed: Oct. 15, 2001

Related U.S. Application Data
(63) Continuation of application No. PCT/EP00/03299, filed on Apr. 13, 2000.

(30) Foreign Application Priority Data
Apr. 15, 1999 (DE) 199 16 969.1

(51) Int. Cl. B67B 5/00; B67D 5/32

(52) U.S. Cl. 222/153.01

(57) ABSTRACT

A shut-off device with an annular sealing seat (6) composed of annular metallic membranes (9, 10) having approximately identical surfaces and joined to each other on their outside diameter by a weld seam (18) and connected on their inside diameter in a tightly sealed manner to the ring (16) by weld seams (19, 20). The two membranes (9, 10) and the ring (16) together form a pressure chamber (11) in which pressure Pₛ is effective and which is connected via a bore (17) to the interior of housing (7) in which pressure P_{b} prevails. Pressure chamber (11) is also connected via a bore (12) and pipe (13) to the external shut-off valve (8). When shut-off device (1) is completely unpressurized, membrane (10) contacts shut-off element (2) at least at least on an interrupted circular line. Operating pressure P_{b} prevails inside pipes (3). This operating pressure should be reliably sealed off from the rest of the shut-off device (1) in each operating phase by the flexible sealing seat (6), the rigid seat (5) and and the shut-Off element (1). Seal gas pressure P_{g} is effective inside the rest of the housing (7) and must be higher than operating pressure P_{b}. Pressure Pₛ prevails inside pressure space (11) inside membrane system (9, 10) and is equal to pressure P_{g} when the shut-off element (1) is at rest. the pressure differential of P_{g} and P_{b} on the annular surface with the outside diameter, the middle seal diameter (22) and the inside diameter of the membrane (9) serves to deform the membranes (9, 10) toward the shut-off element (1), thus compressing the sealing surfaces. Pressure compensation prevails on all other surfaces, especially on those of the membrane (10). In order to displace the shut-off element (1), the compression of the sealing surfaces must be reduced to a minimum. This is achieved by opening the external shut-off valve (8). Since the cross-section of bore (17) is considerably smaller than that of bore (12), pressure Pₛ decreases almost to zero.

### CROSS REFERENCE TO RELATED APPLICATIONS

This application is a continuation of international patent application no. PCT/EP00/03299, filed Apr. 13, 2000 designating the United States of America, the entire disclosure of which is incorporated herein by reference. Priority is claimed from Federal Republic of Germany patent application no. DE 19916 969.1, filed Apr. 15, 1999.

### BACKGROUND OF THE INVENTION

This invention relates to a seal for a translationally moved shutoff element which is moved from a closed position into an open position or in the opposite direction to shut off material streams.

The seal is comprised of metallic components which delimit a pressure chamber to which an external pressure can be applied to achieve a tight seal. The exclusive use of metallic components allows usage in wide temperature ranges and extraordinary wear conditions arising from the frequency of actuation of the device or the composition of the operating medium.

It is essential for the function of this type of seal element that the sealing tightness of the device between the housing and the shutoff element is achieved by means of two sealing seats located in the housing. For differential pressure defined by direction, a rigid sealing seat on the side facing away from the differential pressure is necessary. The side facing the differential pressure must contain an axially movable sealing seat which can also equalize deformations of the housing due to internal pressure and/or external stresses. Stresses from positions outside the housing require a directly proportional stiffness of the movable seating ring corresponding to the spacing of these force introduction points, so that this ring is no longer capable of compensating for deformations of the shutoff element and the housing. Thus, the tight sealing of the entire system is not ensured in every operating state. To realize the basic requirement for tight sealing, which is to allow no constituents of the medium into the housing, in either the closed or the open position of the shutoff device, a pressure can be applied inside the housing by means of a sealing medium. This has the consequence that in case of leaks, only constituents of the sealing medium can reach the operating medium and the shutoff is secure for manual work downstream from the pressure.

In principle, sealing arrangements are known which use expandable sealing elements to effect sufficient surface pressure on the shutoff element. Tubular sealing elements made of elastic synthetic resin materials are, however, only usable within limited boundaries in regard to the upper temperature limit and wear behavior. Particularly with advanced wear, these types of sealing elements tend to bind in the sealing gap to be sealed. Because of this, either the expandability of the sealing elements or the ability to operate the shutoff element is lost.

Known metallic sealing arrangements for generating axial flexibility have the disadvantage that they are hybrid solutions, a combination of metallic delimitation of the pressure chamber to be expanded by external pressure and the transmission of the force arising thereby to elastic sealing elements made of elastomers. The disadvantages described above arise in the same way. For reasons of elastic deformability, the pressure chambers are delimited by multiple parallel membranes whose seal tightness relative to each other cannot be checked during production or in operation. It is necessary for the elastic membrane to be multilayered for reasons of elastic deformability, even at the maximum operating temperature. The failure of one single membrane leads to overall failure of the function of sealing the pressure chamber. The production through forming processes of a membrane assembly to receive the elastic sealing ring, particularly with approximately equal radial thickness, is extraordinarily difficult. Mounting of the elastic sealing ring in the membrane assembly is insufficient, so that varying wear of the elastic sealing ring occurs depending on the initial position in relation to the direction of the translational movement of the shutoff element.

Two metallic membranes are used in the German patent application 196 53 456.9 which cause a sealing effect on a shutoff element through external application of pressure in combination with a pressure inside the housing. The required production techniques are very expensive to carry out, and the reproducibility of the deformation effect in a series of devices is poor. The pressure-tight welding of the membranes to one another and to the removable flange is especially costly. The sealing of the removable flange and of the rigid sealing seat is problematic, as is their axial positioning. The deformation of the device housing with varying internal pressure stress particularly causes wear of the noble metal coating of the metallic sealing element and therefore a diminishing sealing effect of the rigid sealing seat relative to the device housing.

### SUMMARY OF THE INVENTION

The object of the present invention is to provide a seal of the aforementioned type which achieves a uniform sealing effect and wear rate independent of the circumferential position at a relatively low cost, even if the operating medium exerts high temperatures and high pressures on the shutoff element and deformations of the shutoff element and/or external elements of the entire system occur, a high frequency of actuation of the shutoff element is experienced, and aggravating wear conditions due to solid constituents of the medium are possible. In addition, only the sealing gas pressure within the housing is used to generate the sealing effect. The sealing effect of the rigid seat relative to the shutoff element is improved by the effective pressure differential between the sealing gas pressure and the operating pressure.

This object is achieved by the features of the invention as described and claimed hereinafter. It is necessary for understanding of the function to consider the pressure relationships in two different pressure chambers. When the device is in its closed state, these are the operating pressure P_{b} to be shut off between the shutoff element and the connection flange of the device, the pressure P_{g} within the housing, and the actuation pressure Pₛ within the elastic seat. Two membranes optimized to achieve the necessary deformability, which are connected pressure-tight with the housing and are located parallel to the shutoff element, are required. This annular surface differential is sufficient by itself to generate the required surface pressure. It is possible to generate large surface pressures on the seat with relatively small pressures P_{g}. This is also required because the seal between the flexible seat and the shutoff element is to be exclusively metallic. There is a connection between the chamber inside the membrane system and the housing inner chamber, in which the pressure P_{g} is effective. The cross-section of this connection is significantly smaller than the cross-section of the bore to the external connection provided with a small shutoff valve.

The function of the seal can be represented as follows. In the rest state of the device, i.e., in the open or closed state, the membrane which faces the shutoff element is in contact with the shutoff element. The sealing occurs more or less on a circular line. The pressure differential between P_{g} and P_{b} acts on the annular surface between the central sealing diameter and the inner diameter of the membrane, with P_{g} always greater than P_{b}. The chamber within the membrane system has the same pressure as the housing. To actuate the device, the pressure within the membrane system is reduced almost to zero by unblocking the cross-section of the relief bore by opening the small, external shutoff valve. Due to the small cross-section of the connecting bore between the membrane system, the pressure P_{b} is reduced only insignificantly and can fulfill its function even during the actuation of the device. After the final position of the shutoff element has been reached, the external shutoff valve is closed again, and the membrane system seals again relative to the shutoff element.

A second possibility is to divert the pressure within the membrane system, by means of the external shutoff device, into the pressure chamber in which the operating pressure P_{b} is effective. The load release effect of the membrane system is actually not as large, but such measures may be necessary, particularly for poisonous or environmentally hazardous media.

The sealing and contact during the actuation requires a wear protection layer on the outer section of the radius of the membrane which faces the shutoff element. This configuration has the advantage of compensating for all deformations of the device components due to the process. The necessary stiffnesses, particularly of the housing and the shutoff element, and the requirements for shape deviations of the sealing surfaces from the plane can be reduced. This also has consequences for the processing procedures for final processing of the device components relevant for the seal.

The sealing seat fixed relative to the membrane system is rigidly constructed and has an elastic, pressure-tight connection with the housing. This connection consists of an annular membrane which is connected on its outer diameter with the rigid sealing seat and on its inner diameter with the housing. The deformation of the housing under the effect of the pressure P_{b} is therefore decoupled from the sealing seat. In addition to the operating pressure differential which is transmitted via the shutoff element to the rigid sealing seat, the pressure differential between the housing pressure P_{b} and the operating pressure Pₛ also acts on the annular surface between the central sealing diameter of the rigid sealing seat and the inner diameter of the membrane and thus increases the sealing surface pressure.

An embodiment with two rigid seats with sealing membranes constructed as described above on both sides of the shutoff element is also possible.

### BRIEF DESCRIPTION OF THE DRAWINGS

The invention will be described in further detail hereinafter with reference to illustrative preferred embodiments shown in the accompanying drawing figures in which:

FIG. 1 shows an overall view of the shutoff device;

FIG. 2 shows detail I of FIG. 1 with the membrane system in the fully axially unloaded position;

FIG. 3 shows detail I of FIG. 1 with the membrane system in the fully axially compressed position with pressure support P_{g};

FIG. 4 shows detail 11 of FIG. 1 with the rigid sealing seat in the fully axially unloaded position;

FIG. 5 shows detail 11 of FIG. 1 with the rigid sealing seat in the fully axially compressed position with pressure support P_{g};

FIG. 6 shows another version of FIG. 5; and

FIG. 7 shows a version with two rigid seats in the uncompressed position.

### DETAILED DESCRIPTION OF PREFERRED EMBODIMENTS

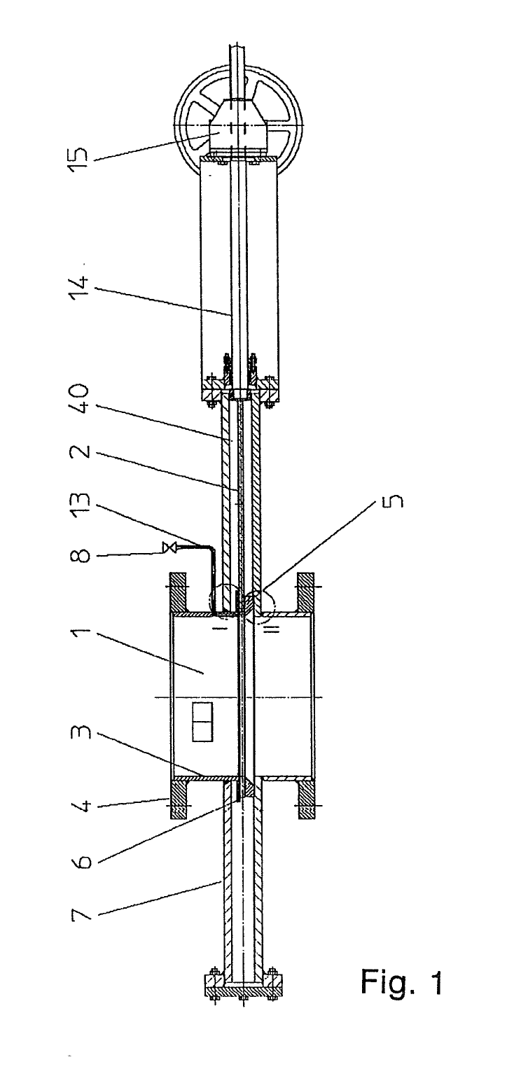

FIG. 1 shows an overall view of a shutoff device 1. It comprises a housing 7, which is connected pressure-tight via tube 3 and flange 4 with an adjoining pipeline (not shown). A shutoff can be achieved by the shutoff element 2 via a rigid seat 5 and a flexible seat 6. The shutoff element 2 is moved via a rod 14 by means of a drive 15 from the open position into the closed position and vice versa. The pressure chamber 11 of the flexible seat 6 is connected in pressure-tight manner via a tube 13 with an external shutoff valve 8.

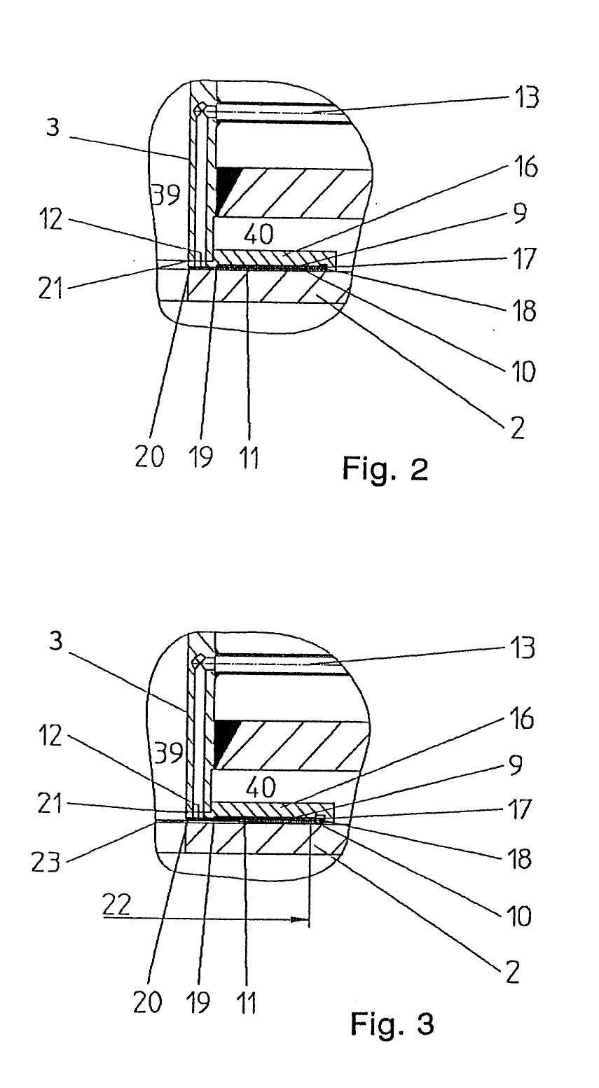

FIG. 2 shows an enlarged view of the flexible sealing seat 6. It essentially comprises annular, metallic membranes 9, 10, which have approximately equal areas. The metallic membranes 9 and 10 are connected on their outer diameter to one another by the welded seam 18 and pressure-tight on their inner diameter to the ring 16 by the weld seams 19 and 20. The two membranes 9 and 10 form a pressure chamber 11 with the ring 16. This pressure chamber 11, in which the pressure Pₛ is effective, is connected via a bore 17 with the pressure chamber 40 of the housing 7, in which the pressure P_{g} is effective. On the other hand, the pressure chamber 11 also has a connection to the external shutoff valve 8 via the bore 12 and the tube 13. The ring 16 is connected pressure-tight by the weld seam 21 with the housing 7. The membrane 10 contacts the shutoff element 2 on at least one uninterrupted, circular line even in the completely unpressurized state of the shutoff device 1.

FIG. 3 shows the flexible sealing seat 6 under deformation due to the effect of the pressures P_{b}, P_{g}, and Pₛ. The operating pressure P_{b} in the pressure chamber 39, which is to be securely sealed by means of the flexible sealing seat 6, the rigid seat 5, and the shutoff element 1 from the rest of the shutoff device 1 in every operating phase, is effective within the tube 3. The sealing gas pressure P_{g} is effective within the remainder of the housing 7 in the pressure chamber 40 and must be higher than the operating pressure P_{b} in the pressure chamber 39. The pressure Pₛ is effective in the pressure chamber 11 inside the membrane system 9, 10 and is equal to the pressure P_{g} when the shutoff element 1 is at rest, i.e. not moving. The differential of the pressures P_{g} and P_{b} on the annular surface having an outer diameter which corresponds to the central sealing diameter 22 and the inner diameter of the membrane 9 serves to deform the membranes 9 and 10 in the direction of the shutoff element I in order to generate a sealing surface pressure. Pressure equalization occurs on all other surfaces, particularly on those of the membrane 10.

In order to move the shutoff element 1, the sealing surface pressure must be reduced to minimum. This occurs by opening the external shutoff valve 8. Because the cross-section of the bore 17 is much smaller than that of the bore 12, the pressure Pₛ sinks almost to the ambient pressure, without allowing the pressure P_{g} to sink significantly. In this way, the abrasion of the wear protection coating on the sealing seats 5, 6 and the shutoff element 2 is reduced to a minimum, and the force required to drive the shutoff element 2 is also reduced.

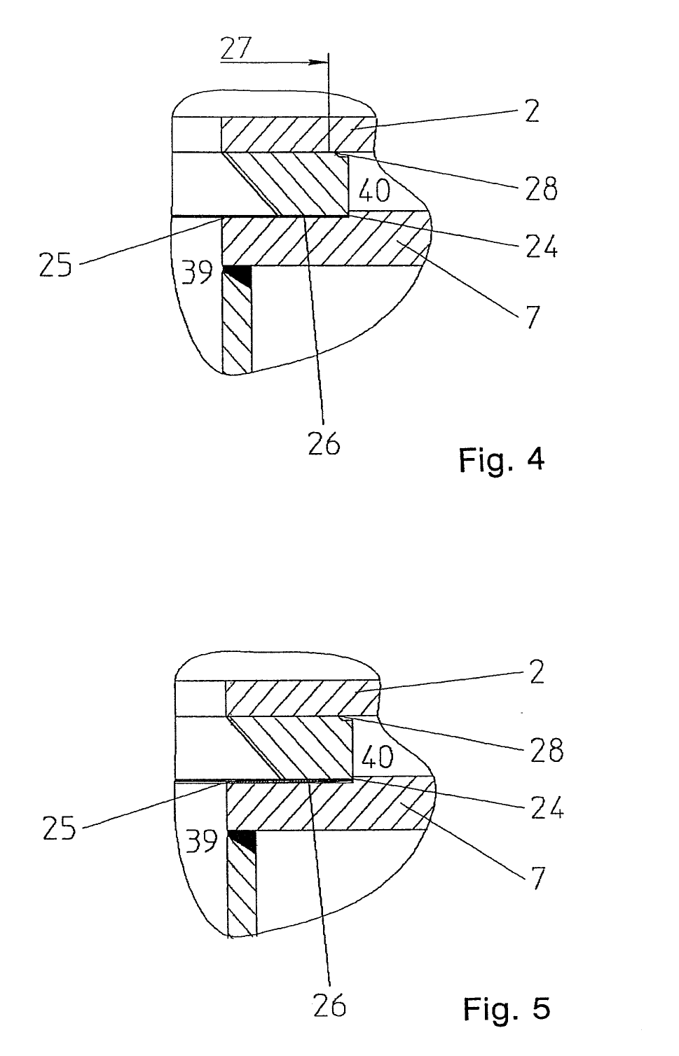

FIG. 4 shows a sectional view through the rigid sealing seat 5 perpendicular to the longitudinal axis of the shutoff element 2. The fixed sealing seat 5 has an elevated seat 28, which seals relative to the shutoff element 2 on the central sealing diameter 27. The fixed sealing seat 5 is axially movable relative to the housing 7 and is connected pressure-tight with the membrane 26 on its outer diameter by means of the weld seam 24. The membrane 26 is connected pressure-tight with the housing 7 by the weld seam 25.

FIG. 5 shows a section through the rigid sealing seat 5 in the direction of the longitudinal axis of the shutoff element 2. Through deformation of the housing 7 under the effect of the sealing gas pressure P_{g}, on one hand, a space arises between the membrane 26 and the rigid sealing seat 5, and, on the other hand, between the membrane 26 and the housing 7. The flatness of the seat 28 is not changed thereby and complete contact with the shutoff element 2 is maintained. In addition, the pressure differential between P_{g} and P_{b} again acts essentially on the entire surface of the membrane 26. The resulting force is transmitted to the rigid sealing seat 5 and is additional sealing surface pressure both on the seat 28 and on the flexible sealing ring 6.

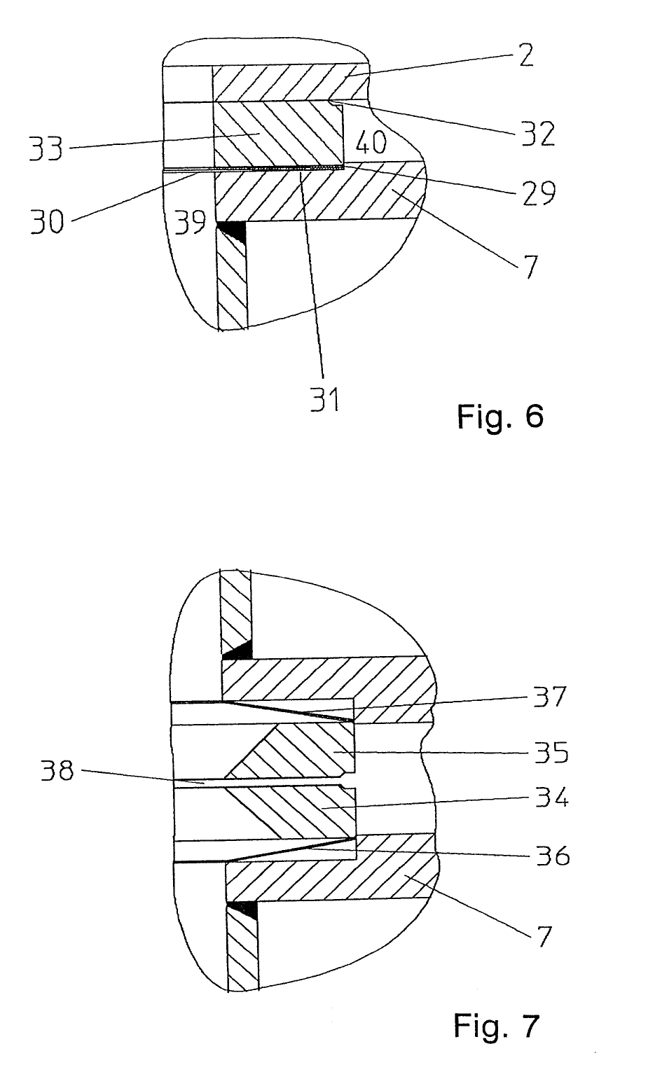

FIG. 6 is a further embodiment of FIG. 5. The difference is in the connection of the membrane 31. It is connected to the housing 7 on the outer diameter by means of the weld seam 29. The inner diameter of the membrane 31 is connected by means of the weld seam 30 with the rigid sealing seat 33. The sealing force generation is analogous to FIG. 5.

FIG. 7 shows the unstressed state of an embodiment with two rigid sealing seats 34, 35. They are connected with the housing 7 in a pressure-tight manner via the membranes 36 and 37. The spacing 38 is smaller than the thickness of the shutoff element 2. During assembly of the shutoff element 2, the spring constants of the membranes 36, 37 are converted into minimum surface pressures. After application of the sealing gas pressure P_{g}, the necessary sealing surface pressure is achieved.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claiimed is:

1. A translationally actuated shutoff device for high operating temperatures, comprising a housing with tubes and flanges, a movable shutoff element, a rigid seat associated with the movable shutoff element, and a flexible seat which contains at least one membrane connected with the housing in a pressure tight manner, said housing containing a first pressure chamber in which an operating pressure (P_{b}) prevails and through which a material stream can flow, and a second pressure chamber in which a sealing gas pressure (P_{g}) exists and into which the shutoff element can be moved to open the shutoff device; said shutoff device further comprising a third pressure chamber which is associated with the flexible seat and in which an actuation pressure (Pₛ) prevails, said third pressure chamber being arranged on a side of the membrane facing away from the shutoff element and having a pressure-tight connection with a connection tube, wherein a bore is provided between the second pressure chamber and the third pressure chamber, and an external valve is connected with the connection tube connected to the third pressure chamber, wherein the pressure in the third pressure chamber can be reduced by opening the external valve before the shutoff element moves; wherein the external valve can be re-closed after movement of the shutoff element, and wherein the sealing gas pressure (P_{g}) is always greater than the operating pressure (P_{b}).

2. A shutoff device according to claim 1, wherein the flexible sealing seat comprises a second membrane, and the two membranes and are constructed as annular, metallic membranes having at least approximately the same inner diameter and the same outer diameter and in the unpressurized state are arranged parallel and adjacent to one another.

3. A shutoff device according to claim 2, wherein the second membrane is at least partially in contact in the unpressurized state with a ring connected with the housing.

4. A shutoff device according to claim 3, wherein the second membrane is connected at its inner diameter with the ring in a pressure-tight manner, and at its outer diameter with the first membrane.

5. A shutoff device according to claim 3, wherein the first membrane is connected at its inner diameter with the ring in a pressure-tight manner.

6. A shutoff device according to claim 2, wherein the two membranes delimit the third pressure chamber, and said third pressure chamber has a closable connection via a bore of the housing, the tube, and the external valve, to the surrounding atmosphere or into the first pressure chamber.

7. A shutoff device according to claim 6, wherein the bore communicating between the third pressure chamber and the second pressure chamber has a smaller cross-section than the cross-section of the bore of the housing.

8. A shutoff device according to claim 1, wherein the first membrane has an approximately circular line contact to the shutoff element when the shutoff device is unpressurized.

9. A shutoff device according to claim 1, wherein the rigid seat is mounted to be axially movable in the direction of the gradient of the operating pressure (P_{b}) and is connected with the housing by an annular membrane.

10. A shutoff device according to claim 9, wherein the outer diameter of the annular membrane is connected with the rigid seat in a pressure-tight manner, and the inner diameter of the annular membrane is connected with the housing in a pressure-tight manner.

11. A shutoff device according to claim 9, wherein the outer diameter of the annular membrane is connected with the housing in a pressure-tight manner, and the inner diameter of the annular membrane is connected with the rigid seat in a pressure-tight manner.

12. A translationally actuated shutoff device for high operating temperatures, comprising a housing with tubes and flanges, a movable shutoff element; a first rigid seat associated with the movable shutoff element, and a second rigid seat, wherein the rigid seats each contain a membrane connected with the housing in a pressure-tight manner; the housing contains a first pressure chamber in which an operating pressure (P_{b}) exists and through which a material stream can flow, and a second pressure chamber in which a sealing gas pressure (P_{g}) exists and into which the shutoff element can be moved to open the shutoff device, said rigid seats being located in the second pressure chamber, and wherein only the sealing gas pressure inside the second pressure chamber of the housing is provided for sealing the rigid sealing seats relative to the shutoff element, and the sealing gas pressure (P_{g}) acts against sides of the membranes which face away from the shutoff element and is always greater than the operating pressure (P_{b}).

13. A shutoff device according to claim 12, wherein a minimum surface pressure of the rigid seats relative to the shutoff element is provided by an elastic deformation of the membranes in the axial direction.
